(19) United States
(12) Patent Application Publication
(10) Pub. No.: US 2022/0108232 A1
(43) Pub. Date: Apr. 7, 2022

(54) System for the accommodation industry for managing reservations as ownable and tradeable digital assets

(71) Applicants: Lyon Hardgrave, Rockville Centre, NY (US); Ronald Homsy, London (GB)

(72) Inventors: Lyon Hardgrave, Rockville Centre, NY (US); Ronald Homsy, London (GB)

(21) Appl. No.: 17/489,457

(22) Filed: Sep. 29, 2021

Related U.S. Application Data
(60) Provisional application No. 63/204,514, filed on Oct. 7, 2020.

(51) Int. Cl. G06Q 10/02; G06Q 30/06; G06Q 50/12

(52) U.S. Cl. CPC G06Q 10/02; G06Q 50/12; G06Q 30/0613

(57) ABSTRACT

Improvements in a system and method for selling, transferring and purchasing of ticket-like hotel or room reservations, which when purchased, become an asset belonging to the owner that grants him the right to use the specified hotel room in the specified hotel on the specified night. According to the process, the hotel tokenizes some or all of its inventory for a set period of time where a token represents room per night. The hotel conducts an initial room offering to investors or consumers at discounted prices. Revenues are collected and passed to hotel owner. The token owner can see their portfolios and can offer to buy, sell or swap tokens. A token owner can redeem his token at hotel on the specified night to gain entry to the room.

### CROSS REFERENCE TO RELATED APPLICATION

This application claims the benefit of Provisional Application Ser. No. 63/204,514 filed Oct. 7, 2020, the entire contents of which is hereby expressly incorporated by reference herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

### Field of the Invention

This invention relates to improvements in apparatus and methods for hotel reservation and related systems and, more particularly, the present system for the accommodation industry for managing reservations for hotel room-nights as ownable, transferable and tradeable digital assets which provide hotel owners with better options to manage their risks and give customers tools to manage their stays.

### Description of Related Art Including Information Disclosed Under 37 CFR 1.97 and 1.98

The hospitality industry is facing an unprecedented crisis. The world's largest hotel chain, Marriott, has said COVID is “having a more severe and sustained financial impact on Marriott's business than 9/11 and the 2008 financial crisis, combined.” Independent hotels are particularly vulnerable as more than 1 in 4 hotels are late on their mortgage payments. Smaller hotels, with more shallow pockets, are particularly vulnerable.

The crisis has exposed the asymmetric risks borne by hotel owners. The current market arrangement, in which customers can make reservations and cancel until just prior to arrival, creates unchangeable and unsustainable risks for hotels. In a severe or prolonged disruption, customers cancel their reservations en masse, and the devastating losses that result are borne solely by the hotel owner.

A number of patents and or publications have been made to address these issues. Exemplary examples of patents and or publication that try to address this/these problem(s) are identified and discussed below.

An Intelligent Hotel Reservation System and Method bearing US provisional application 2009/0030743 was published to LAS VEGAS CENTRAL RESERVATIONS CORP LAS VEGAS CENTRAL RESERVATION CORP. The patent application implies a computerized system and method for making a hotel reservation. In some embodiments there are post-reservation features, such as the ability to continue searching for better prices after a room has been booked.

Another patent application on hotel reservation system without check-in bearing US publication number 2009/0299777 for Hersh Silberman. The hotel reservation system comprises hotel rooms having combination locks electronically set so as to be openable by any one of a plurality of combination codes whenever the combination code is inputted. A computer system accessible through a telecommunications network allows remote sign-in and reservation of a hotel room for a check-in date under a guest identity by payment and selection of a combination code specific to the hotel room. The computer system, upon electronic notification of a selection of a combination code, automatically electronically may set or schedule the setting of the combination lock controlling entry to the reserved hotel room. The computer system may be programmed to automatically electronically set the combination lock at a set time on the check-in date. The hotel may maintain digital records of the codes for each room and of instances of entry into the room using the code.

A patent on Automated hotel reservation processing method and system bearing U.S. Pat. No. 5,864,818 is issued to SF IP PROPERTIES 57 LLC WORLD BUSINESS SERVICES Inc. The patent is on a hotel reservation system receives hotel reservations from a travel agent or other authorized user and enters information relating to the traveler and the reservation into a hotel reservation terminal. The reservation information is transferred to transaction processor via a communications link, where the processor automatically generates transaction documents related to the traveler, the travel agent and the hotel accommodations. These transaction documents are then sequentially transmitted by the processor using a facsimile to various parties having an interest in the reservation transaction. A confirmation document is sent to the hotel for which the accommodations have been reserved. The banking institution through which the transaction has been financed is notified to pay the hotel and others, and the travel agent is also sent a confirming transaction document.

Another patent on System and method for booking of hotel accommodations for travelers bearing U.S. Pat. No. 7,584,110 is issued to Emirates. The patent is on a method of making a hotel reservation includes receiving a reservation request from a booking source, wherein the reservation request is based on an allocation to the booking source from a hotel and wherein the reservation request is price-blind; transmitting the reservation request to the hotel; receiving a confirmation from the hotel; and transmitting the confirmation to the booking source. The booking source can be a consolidator, a travel agent, a tour operator, a Global Distribution System or a wholesaler. The method also includes connecting to the hotel using a web service to transmit the reservation to the hotel. If the reservation request exceeds the allocation, the hotel has an option of accepting the reservation request or declining the reservation request. The method also includes receiving polling inquiries from the booking source prior to transmitting the hotel's confirmation to the booking source. The confirmation from the hotel can be received using a web service. The confirmation can be transmitted to the booking source using a web service. The reservation request can include a “special request.” The method can also include translating parameters of the reservation request from a format of the booking source to a format of the hotel.

Another patent application on hotel/transportation reservation mechanism bearing US publication 2004/0249684 for HOTELZON INTERNATIONAL Ltd. The patent application is on a method for handling a reservation request relating to a reservable item, such as a hotel room. An availability data provider (ADP) actively polls (4-1 . . . 4-4) providers (P1 . . . P4) of reservable items to obtain availability data and receives polling results (PR, 4-1′ . . . 4-4′) from the providers. The ADP maintains (4-5, 4-6) provider-specific availability data on the basis of the polling results. The ADP receives a reservation request (4-17, 4-37) from a client (TA1, TA2, EU1, EU2) and provides the client with a response (4-22, 4-43) to the reservation request. As a result of the active polling, accuracy of the availability data is improved.

The concept of a non-fungible token (NFT) is relatively new, but highly advantageous for this rapidly changing modern world. Basically, the NFT is a unit of data stored on a digital ledger, called a blockchain. The NFT functions like a cryptographic token, but unlike any cryptocurrencies, the NFTs are not mutually interchangeable as each NFT contains unique data that makes it different from any other token on ledger. For hotel reservations, a fungible token is not applicable because the hotel reservation defines the right to stay in a specific hotel in a specific room or class of room on a specific date, and because only one person can hold that specific reservation, each token represents a unique right, so each token needs to have unique data specifying those rights.

There are multiple solutions that have been presented in prior art. However, these solutions are limited and restricted to their conventional architecture, installation system and have considerable shortcomings which adversely affect the convenience with which they can be used. The prior systems have certain limitations including the design of assemblies which make them not suitable for every type of user. Moreover, the ease-of-use ability of these assemblies is also questionable. The closest existing solution in the hotel industry is the Online Travel Agency (OTA), which provides users a similar if more limited search capability than we will provide but remains dedicated to the outdated reservation model.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art. What is needed is a system for the accommodation industry for managing reservations as ownable, transferable and tradeable digital assets presented in this document provides the solution.

### BRIEF SUMMARY OF THE INVENTION

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

It is an object of the system for the accommodation industry to smoothen the hotel reservation method and making it less overwhelming. The advanced hotel reservation method provides multifold benefits to the marketplace as well as the end users to leverage advances in digital marketplaces to move the industry from a reservation model to an asset model.

It is an object of the system for the accommodation industry to provide a system and procedure for providing a platform where a customer purchases ownership of an asset representing one specific night in one specific room in one specific hotel. More specifically, it is the principal object of this invention to provide an ease of use for people where each asset is a specific room for a specific night and is called a Room-Night Token (RNT). A Room-Night Token is a particular type of Non-Fungible Token used specifically for one or more rooms. A RNT functions like a ticket—the holder of the RNT can redeem the token to gain the use of the specific room in the specific hotel for the specific night. The contract rights in the RNT are perishable. If the RNT is not used on its specified night, it becomes worthless, like any ticket for a past event.

It is an object of the system for the accommodation industry to provide a system where the hotel owner can choose to convert as many or as few room-nights as he wishes to RNTs, and then sell those when he wishes. The hotel owner is credited payment for the room immediately upon sale. Once owned by a member of the public, the RNT is fully tradable and can be traded multiple times from owner to owner until the final owner of the RNT eventually decides to redeem the token for use of the room on the specified night.

It is an object of the system for the accommodation industry to provide a user experience that allows any buyer to look inside a hotel, look at each room specifically, and book the exact room or room type they want through the purchase of RNTs. Customers will not only be able to buy and sell RNTs, they will be able to find RNTs that they can swap for their existing RNTs, paying or receiving a differential based on current market conditions. By exchanging RNTs, customers can change their reservations at market value. This user experience will provide customers with control of their hotel booking as well as flexibility in changing rooms, hotels, or even cities.

It is still another object of the system for the accommodation industry to provide a plan where a new process of Initial Room Offering (IRO) is proposed. A hotel owner converts a large set of rooms and dates (e.g., 50% of the rooms and dates for 2021) to RNTs and then offers these RNTs for sale in an initial offering to the public. The hotel owner will likely need to offer the rooms at a discount to the expected retail price, but by doing so, they will receive the full payment for those rooms now.

It is still another object of the system for the accommodation to provide a system where the hotel owner benefits from upfront payment for a large set of rooms, and more importantly, the risk of the value of those rooms falling moves from the hotel to the wide base of room buyers. Under the asset model, the customer has no additional risk compared to the existing pre-payment model for non-cancellable reservations. Also, customers receive a range of additional benefits under this model that are unavailable to them under the existing reservation model.

It is still another object of the system for the accommodation to present a simple and easy way where hotel owners will be able to not only sell future room stays for immediate payment but will have access to all the secondary trading data for their rooms, giving them unprecedented insight into how market events are shaping price and demand.

It is still another object of the system for the accommodation to present a system which is developed in keeping with the guidelines established hereby to offer enhanced “user friendliness” through its features. This application provides a simple interface and is compatible with Apple-IOS® and Android® phones.

It is an object of the system for the accommodation industry to have a unique, entrusted, and advanced hotel reservation method, which can overcome the challenges and limitations of existing hotel reservation methods by making the hotel reservation smooth and less overwhelming. Hence, an attempt has been made in the present invention to provide an advanced hotel reservation method by implementing a non-fungible token (in the form of a Room-Night Token or (RNT) based hotel reservation which converts a hotel reservation into an ownable and tradable instrument. The use of a non-fungible token (NFT) based advanced hotel reservation method addresses the needs which were not fulfilled by the conventional arts. The advanced hotel reservation method is unique, entrusted and highly effective in the marketplace, which is divided in two lifecycles i.e., a lifecycle before check-in to a hotel and a second lifecycle after check-in. The “Before Check-in” process begins with the decision by the hotel to create the reservation NFT for use as a hotel reservation and ends with “check-in”. After check-in, the reservation NFT is augmented with a digital signature of the hotel, creating immutable proof that the reservation was accepted and used by the owner of the reservation NFT or their designate. The reservation NFT is further augmented with the media from the stay at the hotel, creating a unique digital memento of a moment in time. With this feature a family can create an ageless digital memento of a family trip, a bride and groom can present their wedding party with a limited edition NFT commemorating the big day, and a celebrity can capture their time in a hotel or at an event and attach unique media to it and sell a limited edition of the resulting collectible to their fans.

Various objects, features, aspects, and advantages of the present invention will become more apparent from the following detailed description of preferred embodiments of the invention, along with the accompanying drawings in which like numerals represent like components.

### BRIEF DESCRIPTION OF THE SEVERAL VIEWS OF THE DRAWING(S)

FIG. 1 shows a flow diagram illustrating a “Before Check-in” process of an advanced hotel reservation method.

FIG. 2 is a flow diagram illustrating a “Check-in” process of an advanced hotel reservation method.

FIG. 3 is a flow diagram illustrating an “After Check-in” process of an advanced hotel reservation method.

FIG. 4 shows the reservation NFT and the memento NFT.

FIG. 5 shows the before check-in and the after check-in of the Pinktada NFT lifecycle.

FIG. 6 shows the two major components of the Pinktada platform.

FIG. 7 shows the RNT Quarterly bock model.

FIG. 8 shows the Pinktada NFT Lifecycle.

### DETAILED DESCRIPTION OF THE INVENTION

It will be readily understood that the components of the present invention, as generally described and illustrated in the drawings herein, could be arranged and designed in a wide variety of different configurations. Thus, the following more detailed description of the embodiments of the system and method of the present invention, as represented in the drawings, is not intended to limit the scope of the invention, but is merely representative of various embodiments of the invention. The illustrated embodiments of the invention will be best understood by reference to the drawings, wherein like parts are designated by like numerals throughout.

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

### ITEM NUMBERS AND DESCRIPTION

| | |
|---|---|
| 20 Before Check-in | 21create a reservation |
| 22 transfer reservation | 23 additional reservation |
| 25 check-in | 26 final reservation |
| 27 digitally signs | 30 create collectible NFT |
| 31 NFT incorporated | 32 add media |
| 33 customer digitally signs | 34 hotel digitally signs |
| 35 NTF platform digitally signs | 36 NTF collectible minted |
| 37 RNT collectable granted | 38 Pinktada digitally signs |
| 39 each day customer | 40 reservation NFT |
| 41 memento NTF | 47 RNT collectible gifted |
| 48 RNT collectible | 49 RNT collectible sold |
| 50 after check-in | 51 hotel creates RNT |
| 52 hotel sells RNT | 53 wholesale market |
| 54 RNT priced | 55 Final retail buyer |
| 56 RNT expires | 57 customer redeems RNT |
| 58 enables RNT | 59 bank |
| 60 hotel | 61 Pinktada administration |
| 62 hotel management | 63 sumsub |
| 64 traders/investors | 65 pinktada marketplace |
| 66 pinktada booking engine | 67 pinktada customer portals |
| 68 traveler | 69 pinktada engine |
| 70 pinktadacreate RNT | 71 RNT quarterly block |
| 71A pinktada quarterly block | 71B speculators |
| 72 pinktada beaks quarterly | 73 13 RNT weekly blocks3A |
| 73A pinktadaweekly block | 73B RNT block(s) |
| 74 pinktada breaks weekly | 75 individual day |
| 75A pinktada retail marketplace | 75B 1 RNT |
| 76 retail customer | 77 pinktada break quarterly |
| 78 pinktada break weekly | 79 retail individual day |
| 80 pinktada | 81 NFT tokenization |
| 82 marketplace | 83 redemption |
| 84 option for NFT | 85 commemorative NFT. |
| 86 display | 87 distribute |
| 88 derived value | |

The present system and method are directed to an online marketplace allowing hotel owners with better options to manage their risks and give customers unprecedented tools to manage their stays. The system and method disclose a non-fungible token (NFT) based advanced hotel reservation method which is unique, entrusted and highly facilitative, which in turn smoothen the whole way of the hotel reservation process. According to the present invention, the advanced hotel reservation method particularly relates with expanding the functional and operational features of the hotel reservation method by incorporating the advanced technologies as described in the following description.

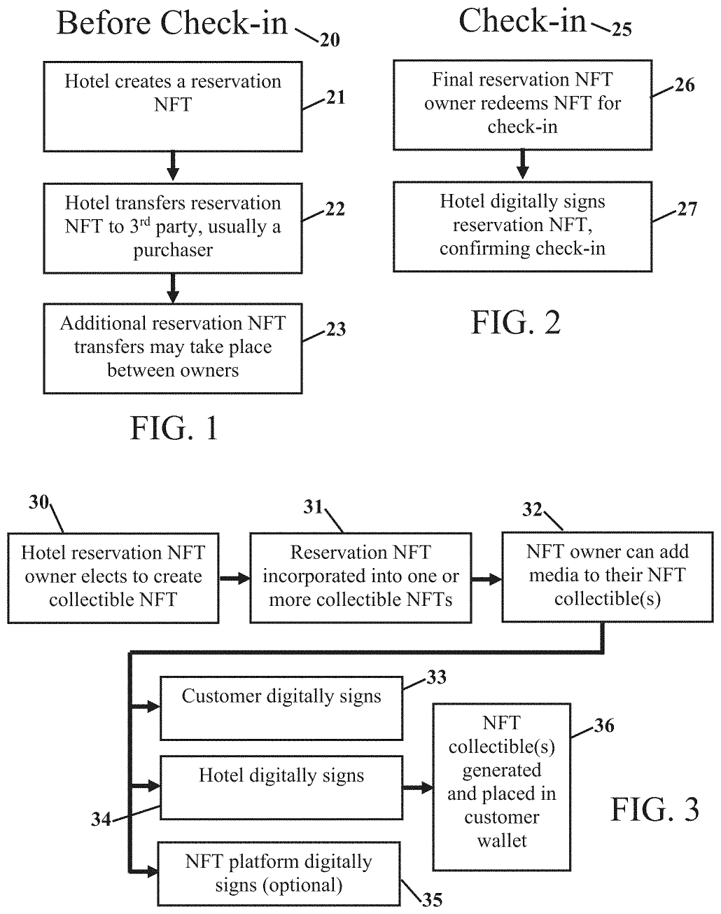

FIG. 1 shows a flow diagram illustrating a “Before Check-in” process of an advanced hotel reservation method. A first lifecycle of the method starts before check-in 20 a hotel. A plurality of process steps are involved in “before check-in” process of the advanced hotel reservation method. The process starts when the hotel decides to create a plurality of reservation 21 NFTs for use as a hotel reservation.

The generation of the reservation NFT 21 is followed by the technical generation process, which is accompanied by a legal process where the hotel agrees to their off-chain legal obligations, such as a bearer or an owner or a purchaser or a customer of the reservation NFT has the right to stay in a specified room within the hotel on a specified night, and encodes said specifics into the reservation NFT. Said specifics include three fields i.e. the name and location of the hotel, the room number or room class, and the date of the night of the stay. Each reservation NFT is unique, and by definition, non-fungible.

The underlying concept of a NFT allows each reservation NFT to carry specific data i.e. the name of the hotel, room specifications, and the night of the reservation, as well as the legal terms of the rights of the owner of the reservation NFT and the obligations of the hotel named on the reservation NFT. The reservation NFT can either be generated directly in a wallet controlled by the hotel or can be generated into a custody wallet controlled by an exchange or other custodian and be held in the custody on behalf of the hotel. The term “wallet” refers to software that allows a NFT owner to access and store their holdings for safekeeping, similar to an online bank account.

The hotel then transfers at least one reservation 22 NFT to the purchaser or third party. Once the reservation NFT has been generated, it is placed in the hotel's wallet. The hotel can hold it or offer it for transfer as it chooses. Usually, the reservation NFT would be sold to the purchaser, effectuating a process similar to that the purchaser making the hotel reservation. Once transferred, the hotel is obligated to provide the final purchaser of the reservation NFT an access to the specified room on the specified night. The hotel can either directly transfer the reservation NFT from the wallet of the hotel to the wallet of the purchaser, or, if the reservation NFT is held in the custody, transfer of ownership of the reservation NFT can be managed by the custodian.

Additional reservation 23 NFT transfers can be take place between the owners. However, the legal obligation on the hotel in the reservation NFT is perishable. Hence at the time of the check-in date, if the owner does not redeem the purchased reservation NFT, the legal obligation of the hotel will be typically expired.

FIG. 2 is a flow diagram illustrating a “Check-in” 25 process of an advanced hotel reservation method. A few process steps are involved in the “check-in” 25 process of the advanced hotel reservation method. The final reservation 26 NFT owner redeems the NFT for check-in to the hotel. On the reservation date specified in the reservation NFT, the owner of the reservation NFT, or their designate, can either redeem the reservation NFT to gain admittance to the specified room as per the terms of the NFT reservation standards, or if the owner, or their designate, does not redeem the reservation NFT, the legal obligation on the hotel to provide the specified room for the specified night expires. More precisely, the reservation NFT continues to exist as a token, but there is no longer any obligation by the hotel on the reservation NFT.

After redemption of the reservation NFT by the owner, or their designate, the hotel digitally signs 27 the reservation NFT, adds a timestamp and a signature, and confirms the check-in of the owner, or their designate. The digital signature 27 is recorded on the blockchain at the time of signing, hence creating an immutable record that the reservation NFT was redeemed.

A second lifecycle of the method starts after check-in, wherein the reservation NFT is transformed from a utilitarian instrument for ownership and transferability of reservations to a collectible/memento form of the reservation NFT. A plurality of process steps are involved in an “After check-in” process of the advanced hotel reservation method. FIG. 3 is a flow diagram illustrating an “After Check-in” process of an advanced hotel reservation method. The owner or the customer elects to create at least one collectible NFT 30 memento, wherein the memento NFT is a representation of unique ownerships for items such as photos, videos, audio, and other types of digital files through the memento NFTs. The memento NFT starts with the reservation NFT, which is now a digitally signed record that the customer signed in under their reservation.

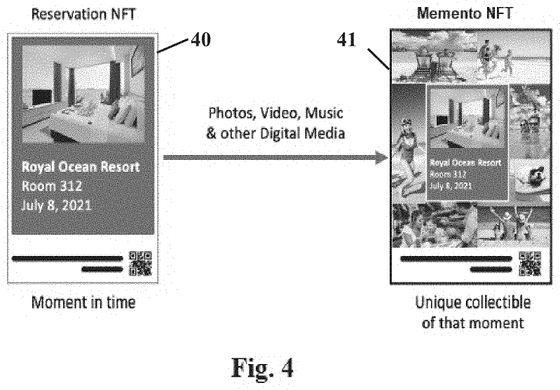

The reservation NFT is incorporated 31 into one or more memento NFTs as shown in FIG. 4. After incorporation of the reservation NFT into the memento NFT, the customer can add media 32 to their memento NFT 31. The customer can feed the memento NFT with personal photos, video, music, and other media. The customer can select from templates to format the media or use their own format. The media is saved on a secure server and the location of that media is added to the memento NFT.

After the customer uploads all the media on the memento NFT, the customer digitally signs 33, the hotel digitally signs 34, and optionally the NFT platform digitally signs 35 the memento NFT. The digital signatures are not mandatory and are solely based on the customer's wish. A timestamp and or GPS marker can be added to the NFT event being memorialized. Moreover, the addition of each digital signature and timestamp increase assurance in the memento NFT.

The memento NFT is minted and placed in a customer's wallet. The memento NFT creation process is completed after the digital signatures have been added. The memento NFT can either be minted 36 directly in the customer's wallet or can be minted into the custody's wallet controlled by the exchange or other custodian and be held in custody on behalf of the customer. The customer now has ownership of an absolutely unique and immutable record of the night or nights of the reservation. The customer can choose to display the memento NFT, gift it, or offer it for sale, among other uses.

The memento NFTs like other collectibles are used to memorialize a special event in digital format. A set of memento NFTs can be shared among a group of travelers as keepsakes. The memento NFTs in form of a set of wedding NFTs can be gifted as mementos to groomsmen or bridesmaids. The memento NFTs in form of a set professional NFTs can be minted after a conference or class to commemorate attendance. The memento NFT as a NFT capturing a celebrity or athlete's night at a hotel, complete with exclusive media, can be marketed to fans or displayed by the hotel on the wall of the room where the celebrity slept. In all these cases, the memento NFT is a unique and irreproducible keepsake of a moment and place in time, and as a result, will have high collectability value.

According to an embodiment, the reservation NFT is embedded with an additional functionality in the form of a smart contract. The smart contract is a kind of computer program which is self-executing with the terms of the agreement between the hotel and the bearer being directly written into lines of code, and intended to control or document legally relevant events and actions according to the terms of the smart contract. The code and the agreements contained therein can exist across a distributed, decentralized blockchain network.

The smart contract allows the reservation NFT to not only point to a designated set of media but to further grant the owner of the reservation NFT the right to other digital services as delineated within the smart contract. Further, the smart contract in the reservation NFT can automatically capture royalties on transactions and send them to the wallet defined within the smart contract. Within the hotel reservation exchange, the hotel can be sent revenue any time the hotel reservation is transacted or appreciates in value. Also, the smart contract enables future traded value to be shared with the hotel and/or the creator of the NFT. Both the reservation NFTs and the memento NFTs can be embedded with the smart contracts that attach additional value to the reservation. For instance, the reservation NFT could include rights for other experiences. These other experiences could exist beyond the time of the reservation itself and give the token value beyond the expiration. For example, the reservation NFT might include rights for a price discount on future stays, perhaps on a specified anniversary of the reservation NFT.

FIG. 4 shows the reservation NFT and the memento NFT. The reservation NFT is immutable proof that a reservation was created. After check-in, the reservation NFT 40 can be augmented with the digital signature of the hotel, creating immutable proof that the reservation was accepted and used by the owner of the reservation NFT 40. The reservation NFT 40 can further be augmented with the media from the stay, creating a unique digital memento of a moment in time 40.

The NFT is a wholly autonomous bearer instrument granting room access, so it can be transferred from one owner to another, allowing reservation rights to be moved seamlessly, without requiring the hotel itself to accurately update its intel systems. Since the NFT can be transferred, it can be traded with immediate settlement. An atomic swap can be created with the NFT on one side and a cryptocurrency or similar tokenized method of payment on the other.

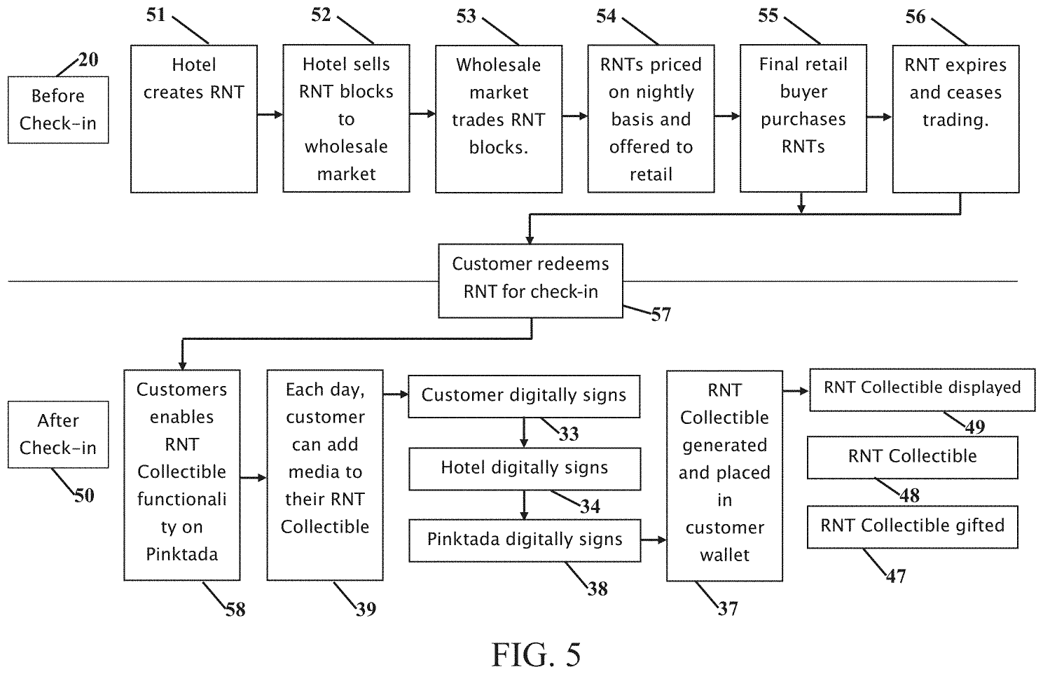

FIG. 5 shows the before check-in and the after check-in of the Pinktada NFT lifecycle. Before Check-in 20 the cycle is essentially the same as previously described use of an Non-Fungible Token (NFT) to represent a reservation. This process starts when the hotel creates a Room Night Token (RNT) 51. The technical generation process is accompanied by a legal process where the hotel agrees to their off-chain legal obligations, namely that the bearer of the token has the right to stay in the named room within the hotel on the named night.

The hotel creates NFTs 51. The minting of an NFT is a publicly defined process, typically specified in publicly available documentation related to the NFT standard and the specifics of the blockchain being used. The technical minting process is accompanied by a legal process where the hotel agrees to their off-chain legal obligations, namely that the bearer of the token has the right to redeem the token to stay in the named room within the hotel on the named night and encodes those specifics into the NFT. Those specifics include three fields—the name (and location) of the hotel, the room number or room class, and the date of the night of the stay. The NFT can either be minted directly in a wallet controlled by the hotel or can be minted into a custody wallet controlled by an exchange or other custodian and he held in custody on behalf of the hotel.

The hotel can hold its RNTs, sell them individually, or group them into “RNT Blocks”. RNT Blocks allow the hotel to sell a bulk set of RNTs in a single transaction in the wholesale market 52. Once an RNT block is sold by the hotel to a 3^{rd} party, that 3^{rd} party can resell the RNT block in the wholesale marker to other 3^{rd} parties, who can then resell again as they see fit. At any time, the owner of an RNT block can choose to break into small RNT blocks or into individual RNTs. Upon breaking a block into smaller units, each smaller block may be offered for sale in the marketplace. When an RNT block is broken into individual RNTs, each RNT can be priced 54 individually and offered for sale to retail buyers, who can purchase them 55. After purchase, the RNT or RNTs are transferred to the account or wallet of the buyer.

The RNT can continue to be traded, transferred, or swapped until the RNT reaches its trading expiration at which time the first lifecycle ends 56. At that time, the RNT can no longer be transacted on the Pinktada as an RNT. The owner of the RNT at that time can either redeem the RNT to gain admittance to a room as per the terms of the RNT reservation language, or if the owner does not redeem the RNT, it expires worthless. More precisely, the RNT continues to exist as a token, but there is no longer any obligation by the hotel to provide accommodation.

At the time of the check-in date, if the owner does not redeem the RNT 57, the legal obligation of the hotel to provide the room for that night will typically expire 56.

At confirming the after check-in 50, the NFT is transformed from a utilitarian instrument for managing reservations to a “memento” form of NFT, similar to the collectible NFTs currently popular. Each memento NFT is a unique, digitally signed record of the events at the day in that room of the hotel. It is a timeless, immutable record of that moment in time.

The customer chooses to enable the RNT 58 functionality on Pinktada to create a collectible NFT. The customer 39 can add media to their RNT collectible 37. The customer digitally signs 33, the hotel digitally signs 34 the NFT, adding a timestamp and signature. This digital signature is recorded on the blockchain at the time of signing, creating an immutable record that the NFT was redeemed. Pinktada digitally signs 38. The resulting RNT collectible is minted and placed in the customer's wallet or held in a customer wallet on behalf of the customer 37.

The customer now has ownership of an absolutely unique and immutable record of the night or nights. Like other collectibles that show moments in time—a ticket stub, a game worn jersey, or a yearbook, for example—the RNT collectible can be displayed, gifted 47, 48, 49. The NFT is a unique and irreproducible keepsake of a moment and place in time, and as a result, will have high collectability value.

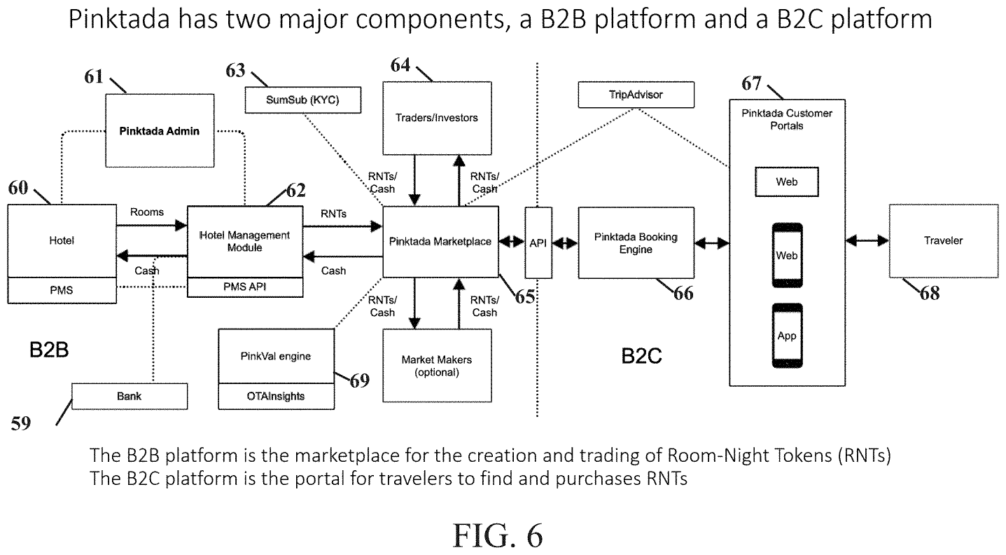

FIG. 6 shows the two major components of the Pinktada platform, the B2B platform that is the marketplace for the creation and trading of room night tokens (RNT) and the B2C platform which is the portal for travelers to find and purchase RNTs. The hotel 60 contracts to sell rooms with Pinktada and manages those rooms on the hotel management module 62, while the hotel management module 62 makes revenue from the sales of RNTs available to the hotel 60 and the hotel's bank 59. The Pinktada administration 61 oversees the creation of reference data and the management of hotel specific data on the hotel 60 and the hotel management module 62.

The hotel management module 62 manages the pricing and availability of RNTs on the Pinktada marketplace 65. Sales revenues on the Pinktada marketplace are available to the hotel through the hotel management module 62. A Know-Your-Customer (KYC) vendor 63 validates identity and liveness of participants on the Pinktada marketplace 65. The Pinktada engine with OTA Insights 69 supplies hotel room pricing data to the Pinktada marketplace 65. The traders/investors exchange 64 RNTs and cash on the Pinktada marketplace 65. The (optional) Market makers also exchange RNTs and cash on the Pinktada marketplace 65.

The Pinktada marketplace 65 uses an API to connect between the B2B and the B2C sections of the platform. The API allows for live pricing and hotel room data to be made available to the Pinktada Booking Engine 66. The Pinktada booking engine 66 searches the booking data. A traveler 68 can access the booking engine through various user interfaced known as customer portals. Each of these custom portals are specialized for a type of interface technology—either web, mobile web, or mobile phone app.

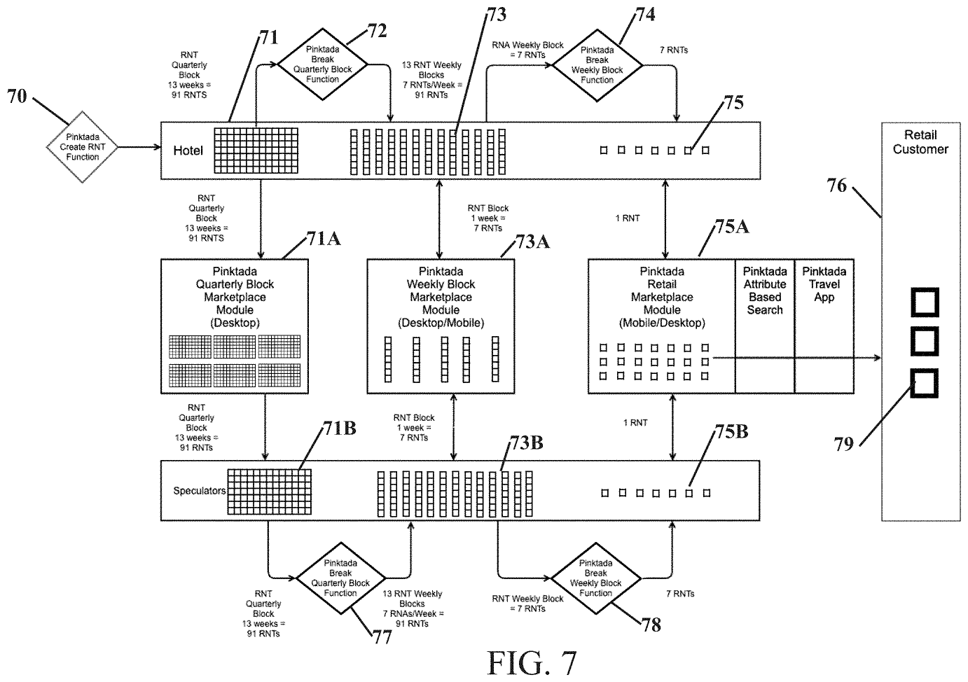

FIG. 7 shows the RNT Quarterly bock model. While not strictly required, the Pinktada marketplace typically combines a set of newly generated RFTs into a single block. RFT blocks represent a set of RNTs with the same hotel and room number and a contiguous set of dates. Pinktada supports a “weekly” block with seven contiguous RNTs and a “quarterly” block 71 with 91 contiguous RNTs.

In the Pinktada create RNT function 70 traders on Pinktada, including the hotel itself, can choose at any time to break apart a block into its component pieces. A quarterly block 71 can be broken 72 into 13 weekly blocks 73, with each weekly block then becoming a separate trading instrument, requiring a separate price. The Pinktada quarterly block marketplace module 71A allows for viewing and trading of quarterly blocks. At any time, the owner of a quarterly block can choose to activate the Pinktada Break Quarterly Block Function 77. This function converts the quarterly block (containing 91 RNTs) into a 13 weekly blocks (each containing 7 RNTs).

Weekly blocks can be viewed and traded in the Pinktada weekly block marketplace module 73A At any time, the owner of a weekly block 73B can choose to activate the Pinktada Break Weekly Block Function 78. This function converts the weekly block (containing 7 RNTs) into 7 separate daily RNTs (each representing a single hotel room-night) 75B.

Once the RNTs are separated, they can be priced separately (on a per night basis) and be made available for booking by a retail customer. The Pinktada retail marketplace module 75A allows for searching and viewing of all RNTs 75B that are for sale. The Pinktada retail marketplace 75A assigns attributes to the RNT(s), enabling attribute-based search, so RNTs can be searched through any Pinktada customer portal, either the web, the mobile web, or the Pinktada app. Through the customer portal, a retail customer 76 can purchase RNTs and view details of their hotel bookings 79.

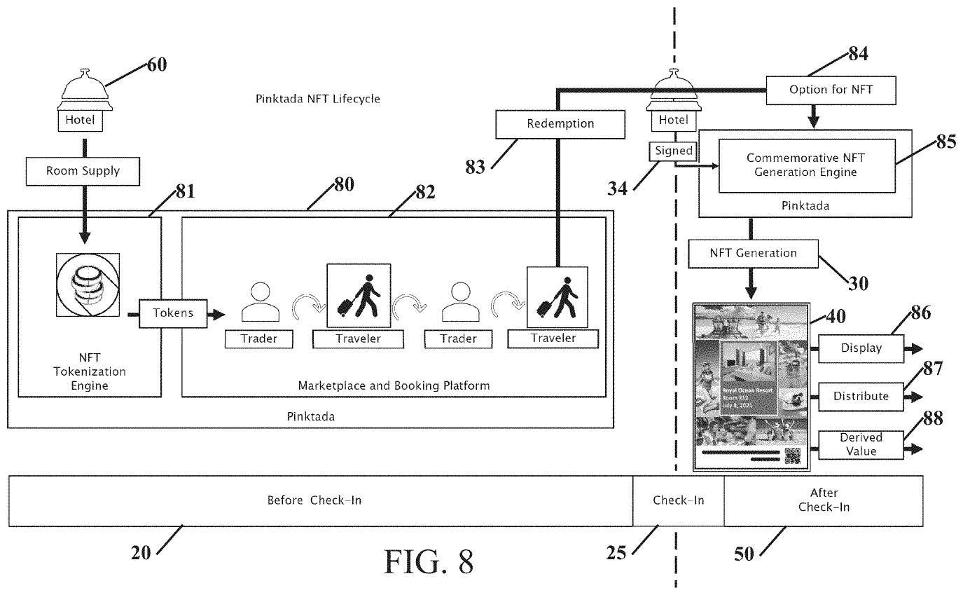

The Pinktada platform enables two related NFT lifecycles, a lifecycle before check-in to the hotel and a second lifecycle after check-in. FIG. 8 shows the Pinktada NFT Lifecycle. Before check-in 20, the hotel 60 has a room supply that are transferred through the Pinktada 80 into an NFT tokenization engine 81 where they are converted into RNTs into the marketplace and booking platform 82. Within the marketplace and booking platform there are travelers and traders can trade and transfer the token, until a final token holder chooses to redeem the token at the hotel (redemption) 83. Redemption allows the final token holder or their designate to check-in. The hotel can digitally sign the RNT 34 to record the check-in. After check-in 50 the customer can choose to convert their RNT into a commemorative NFT 84, a process in which Pinktada uses a commemorative NFT 85 generation engine to mint a commemorative NFT 30. The commemorative NFT 40 is minted into a customer's wallet or custodial wallet maintained by Pinktada. The commemorative NFT is available to the customer to be displayed 86 or distributed 87. The commemorative NFT can also contain smart contract language enabling derived value (e.g. price discounts for recipients of the NFT) 88.

There are typically two ways of pricing the room-night in the legacy “reservation” model. The first pricing model, used with most traditional reservations, allows the customer to cancel the room shortly before the specific night at no cost to them, even if the room was booked a year ahead of time. If the hotel cannot rebook the room, the hotel loses revenue for the full value of the room.

In the second pricing model, the more recent “pre-pay” model, the customer pays ahead of time, usually at a discounted rate, but loses their payment if they cancel at any time afterwards. Both versions of the “reservation” model are fundamentally flawed. They penalize one party or the other the full value of the room for a cancellation. In the traditional model, the hotel carries all the risk. In the pre-pay model, the customer carries all the risk.

Thus, specific embodiments of a system for the accommodation industry for managing reservations as ownable and tradeable digital assets have been disclosed. It should be apparent, however, to those skilled in the art that many more modifications besides those described are possible without departing from the inventive concepts herein. The inventive subject matter, therefore, is not to be restricted except in the spirit of the appended claims.

1. A system and method for the accommodation industry for managing reservations as ownable and tradeable digital assets comprising:
a hotel creating at least one reservation as a Non-Fungible Token (NFT) to represent a NFT reservation;
said hotel transfers said NFT reservation to a purchaser;
an owner purchases said NFT reservation from purchaser;
said NFT reservation is redeemed by said hotel;
said hotel digitally signs said NFT reservation to confirm a check-in;
said owner creates a collectible NFT;
said NFT reservation is converted into said collectible NFT.

2. The system and method of claim 1, where said at least one reservation for a room and a night is an individual asset.

3. The system and method of claim 2, where each token NFT has a specific said hotel, said room and said night.

4. The system and method of claim 1, where said purchaser purchases a token NFT.

5. The system and method of claim 1, where owing said token NFT gives said purchaser a right to said hotel's room on specific night.

6. The system and method of claim 1, where said token NFT is a tradeable asset.

7. The system and method of claim 1, where said purchaser and/or said owner can use, swap, trade or change said token NFT.

8. The system and method of claim 1, where said at least one reservation is for a block of one week comprising of 7 nights.

9. The system and method of claim 1, where said at least one reservation is for block of one quarter of a year comprising of 91 nights.

10. The system and method of claim 1, further includes a customer digital signature.

11. The system and method of claim 1, further incudes a digital signature from a broker.

12. The system and method of claim 1, where said collectible NFT is sellable.

13. The system and method of claim 1, where said collectible NFT memorializing an event in a digital format.

14. The system and method of claim 1, where said collectible NFT is sharable among at least one of a traveler as a keepsake, a set of wedding NFTs to be gifted as mementos to groomsmen or bridesmaids, a set of professional NFTs generated after a conference or class to commemorate attendance, a NFT capturing a celebrity or athlete's night at a hotel, an exclusive media and a marketed tool.

15. The system and method of claim 1, where said collectible NFT is sellable asset.

16. The system and method of claim 1, where said collectible NFT is sellable for a royalty.

17. The system and method of claim 1, where said collectible NFT pays a royalty with each transaction.

18. The system and method of claim 1, where said collectible NFT appreciates in value with each transaction.

19. The system and method of claim 1, where said NFT reservation is a perishable asset.

20. The system and method of claim 1, where said NFT provides future derived rights to the then current owner of the collectible NFT.
